(19) United States
(12) Patent Application Publication
(10) Pub. No.: US 2018/0331569 A1
(43) Pub. Date: Nov. 15, 2018

(54) Technique For Lowering Inrush Current To An Uninterruptible Power Supply With A Transformer

(71) Applicant: VERTIV SRL, Castel Guelfo (IT)

(72) Inventors: Stefano PECORARI, Modena (IT); Andrea PETTENO, Arese (IT); Livio TILOTTA, Imola (IT); Luigi BALMA, Bologna (IT)

(21) Appl. No.: 15/595,183

(22) Filed: May 15, 2017

(51) Int. Cl. H02J 9/06; H02M 1/32; H02H 3/28

(52) U.S. Cl. CPC H02J 9/062; H02M 2001/325; H02H 3/283; H02M 1/32

(57) ABSTRACT

A system and method is presented for lowering inrush current to an uninterruptible power supply. During a startup phase, an AC voltage is applied to the secondary winding of a transformer interposed between an input power supply and a rectifier. An active rectifier coupled to the secondary winding of the transformer is operated as an inverter and supplies the voltage to the secondary winding of the transformer during the startup phase. The magnitude of the AC voltage applied to the secondary winding of the transformer is initially less than the magnitude of the input voltage and is increased gradually over time until it reaches the magnitude of the AC input voltage. In this way, the magnetizing flux of the transformer is increased from zero to a steady-state without having the transformer saturate.

### FIELD

The present disclosure relates to a technique for lowering inrush current to an uninterruptible power supply which employs a transformer.

### BACKGROUND

An uninterruptible power supply is an electrical apparatus that provides emergency power to a load when the input power source fails. Typically, the UPS includes a rectifier that converts AC input power to DC power and an inverter that converts the DC power from the rectifier back to AC power. In some instances, an input transformer may be connected between the input power source and the rectifier. When a transformer is first energized, an inrush current many times larger than the rated transformer current can flow into the transformer for several cycles. Such large inrush currents can damage certain circuit components and require additional design consideration as well as associated cost to counter the effects of any large inrush currents.

One technique for lowering inrush current in a UPS with a transformer is presented in this disclosure.

This section provides background information related to the present disclosure which is not necessarily prior art.

### SUMMARY

This section provides a general summary of the disclosure, and is not a comprehensive disclosure of its full scope or all of its features.

A power supply system is provided which implements a technique for lowering inrush current. The system includes: a transformer with a primary winding is configured to receive an AC input signal from a power supply; a switch electrically coupled between the power supply and the primary winding of the transformer; an active rectifier electrically coupled between the secondary winding of the transformer and a DC bus; a precharge circuit electrically coupled between the power supply and the DC bus and a controller interfaced with the precharge circuit and the active rectifier. The precharge circuit applies a DC voltage to the DC bus in response to a control signal.

The controller determines when AC voltage at the primary winding of the transformer equals the AC input signal and closes the switch in response to a determination that the AC voltage at the primary winding of the transformer substantially equals the AC input signal. The controller further provides the control signal to the precharge circuit during a startup phase and discontinues providing the control signal to the precharge circuit when the switch is closed. The controller also operates the active recitifier as an inverter during the startup phase.

In another aspect, a method is presented for lowering inrush current to an uninterruptible power supply. The method includes: providing a transformer, where the primary winding is configured to receive an AC input signal from a power supply; opening a switch interposed between the power supply and the primary winding of the transformer during a startup phase; applying an AC voltage to the secondary winding of the transformer, where magnitude of the AC voltage is less than magnitude of the AC input signal; increasing the magnitude of the AC voltage over time until the magnitude of the AC voltage on primary winding of the transformer equals magnitude of the AC input signal; determining whether the magnitude of the AC voltage on primary winding of the transformer equals the magnitude of the AC input signal; and closing the switch in response to a determination by the controller that the magnitude of the AC voltage equals the magnitude of the AC input signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram depicting a typical uninterruptible power supply (UPS);

FIG. 2 is a block diagram depicting one technique for lowering inrush current in a UPS;

FIG. 3 is a flowchart illustrating a portion of the control implemented by the controller;

FIG. 4 is a schematic of an example embodiment for implementing the technique for lowering inrush current in the UPS; and

FIG. 5 is a diagram depicting the ramping up of the AC voltage applied to the secondary winding of the transformer.

Corresponding reference numerals indicate corresponding parts throughout the several views of the drawings.

### DETAILED DESCRIPTION

Example embodiments will now be described more fully with reference to the accompanying drawings.

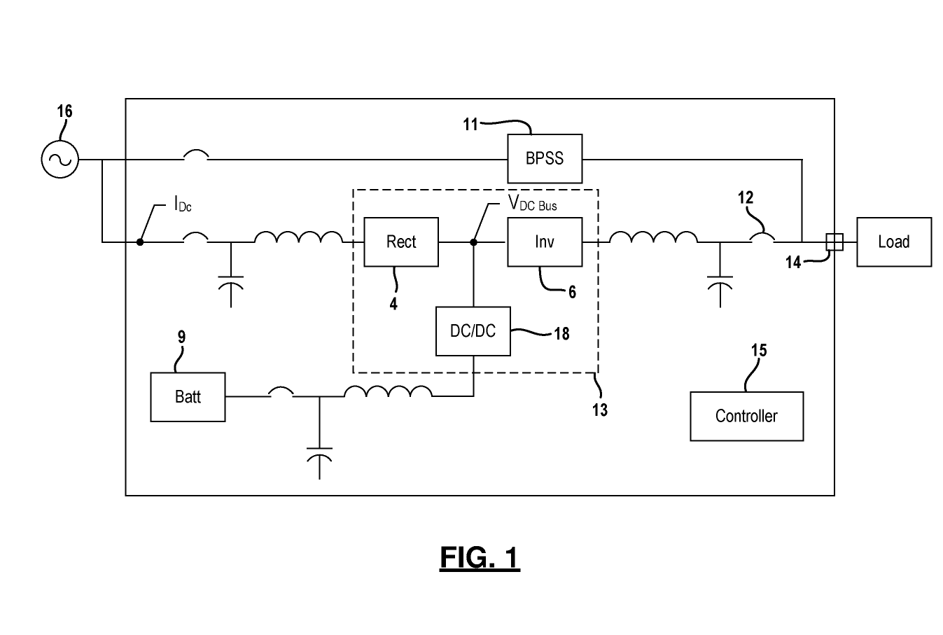

FIG. 1 is a simplified schematic of a typical uninterruptible power supply 10. An uninterruptible power supply (UPS) 10 is typically used to protect computers, data centers, telecommunications equipment or other electrical equipment. The UPS 110 generally includes a bypass switch 11, a UPS switch 12, a UPS converter 13, an output terminal 14 and a controller 15. In the example embodiment, the bypass switch 11 is coupled between the primary power source 16 and the output terminal 14. The bypass switch 11 is configured to receive an AC input signal from the primary power source 16. In a similar manner, the UPS converter 13 is coupled between the primary power source 16 and the output terminal 14 and is configured to receive an AC signal from the primary power source 16. The UPS switch 12 is interposed between an output of the UPS converter 13 and the output terminal 14.

The UPS converter 13 further includes a rectifier 4, an inverter 6, a DC/DC converter 18 and a secondary power source 9, such as battery. The rectifier 4 converts the AC input from an AC signal to a DC signal; whereas, the inverter 6 converts a DC signal to an AC signal. The DC/DC converter 18 interfaces the battery 9 to the main DC bus. The inverter 6 is configured to receive an input signal from either the rectifier 4 or the battery 9. In normal operation, the rectifier 4 supplies the DC signal to the inverter 6 and the DC/DC converter 18 provides a charging current for the battery 9. If the primary power source 16 is not available or the rectifier cannot otherwise provide enough power, the DC/DC converter switches from a charging mode to a discharging mode and the battery 9 supplies the input signal to the inverter 6. Such converter arrangements are known in the art.

The controller 15 monitors the operating conditions of the UPS 10 and controls the bypass switch 11 and the UPS switch 12 depending on the selected mode of operation and the operating conditions. In an exemplary embodiment, the controller 15 is implemented as a microcontroller. It should be understood that the logic for the control of UPS 10 by controller 15 can be implemented in hardware logic, software logic, or a combination of hardware and software logic. In this regard, controller 15 can be or can include any of a digital signal processor (DSP), microprocessor, microcontroller, or other programmable device which are programmed with software implementing the above described methods. It should be understood that alternatively the controller is or includes other logic devices, such as a Field Programmable Gate Array (FPGA), a complex programmable logic device (CPLD), or application specific integrated circuit (ASIC). When it is stated that controller 15 performs a function or is configured to perform a function, it should be understood that controller 15 is configured to do so with appropriate logic (such as in software, logic devices, or a combination thereof).

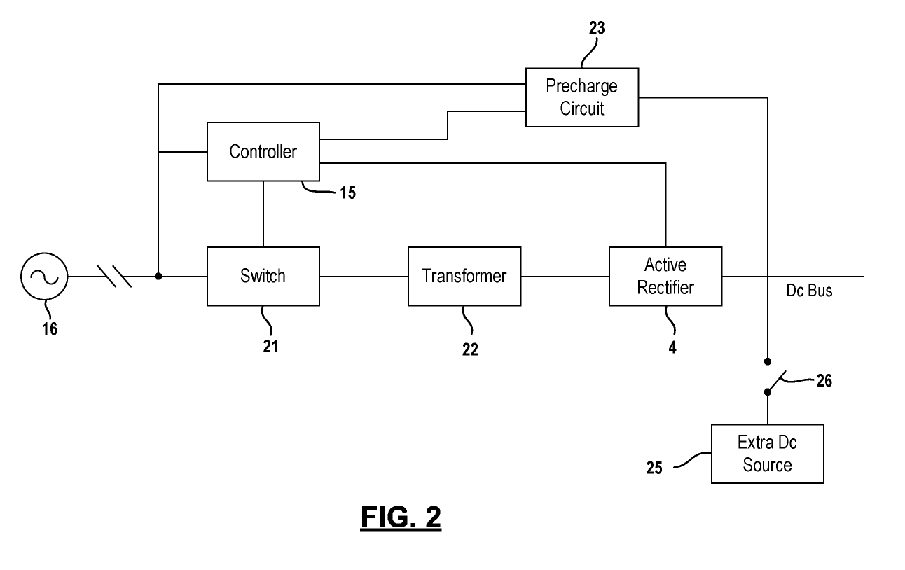

FIG. 2 depicts one technique for lowering inrush current in a UPS 10 having an input transformer 22 interposed between the primary power source 16 and the rectifier 4. The transformer 22 includes a primary winding and a secondary winding. The primary winding of the transformer 22 is configured to receive an AC input signal from the primary power supply 16. In some instances, the transformer has multiple taps at its primary side to adapt different voltages. The rectifier 4 is electrically coupled between the secondary winding of the transformer 22 and a DC bus which leads to the load.

A switch 21 is electrically coupled between the primary power supply 16 and the primary winding of the transformer 22. In one embodiment, the switch 21 is further defined as a contactor that is interfaced with the controller 15. It is understood that relays as well as other types of switches may be used in place of the switch 21.

A DC bus precharge circuit 23 is electrically coupled between the power supply and the DC bus. During a startup phase, the precharge circuit 23 is used to apply a DC voltage to the DC bus. In an example embodiment, the transformer 22 may function as a step down, for example from 230 volts to 180 volts. In the example embodiment, the precharge circuit 23 includes a switch, a resistor, and a rectifier coupled in series between the power supply and the DC bus. In an alternative embodiment, the precharge circuit 23 may be supplied input power by another power source, such as the backup battery 9 of the UPS. Other arrangements for the precharge circuit 23 also fall within this scope of this disclosure.

To avoid an inrush current to the transformer 22, a controlled voltage is applied to the secondary side of the transformer 22 during a startup phase. Before the system is energized, switch 21 is open and thus the transformer 22 is not energized. During a startup phase, the controller 15 provides a control signal to the precharge circuit 23 and the precharge circuit 23 in turn supplies a DC voltage to the DC bus. Specifically, the DC voltage is supplied to the output side of the active rectifier 4. An extra DC source 25 can also supply voltage via a switch 26 to the DC bus during the startup phase. In one embodiment, the extra DC source is the battery from the UPS. In other embodiments, the extra DC source is another rectifier that is connected to the DC bus. The extra DC source may be needed to perform a voltage ramp at secondary side of the transformer 22 as further described below.

Additionally, the controller 15 operates the active rectifier 4 as an inverter during the startup phase. In one embodiment, the active rectifier 4 includes at least one transistor. During the startup phase, the controller 15 biases the transistor of the active rectifier 4 so as to generate an AC voltage at an input of the active rectifier 4. Because the input of the active rectifier 4 is coupled to the secondary winding of the transformer 22, this voltage magnetizes the core of the transformer 22. When the switch 21 is subsequently closed and power is applied to the primary side of the transformer 22, the core is already magnetized such that the inrush current is minimized or eliminated.

In the example embodiment, the controller 15 modulates the active rectifier 4 properly to generate a sinusoidal voltage at the primary side of the transformer 22. More specifically, the controller modulates the active rectifier 4 so that the sinusoidal voltage at the primary side of the transformer 22 matches, in terms of phase and amplitude, the phase and amplitude of the input voltage from the primary power supply 16.

Once the controller 15 determines that the voltage on the primary side of the transformer matches the input voltage from the primary power supply 16, the controller 15 closes switch 21, thereby completing the startup phase. It should be understood that matching in this context means that the magnitudes are equal within a tolerance, such as +/−5%, and their phases are in synch within a tolerance, such as +/−three degrees. Concurrently therewith, the controller 15 discontinues supply a control signal to the precharge circuit 23 and the precharge circuit 23 no longer supplies a DC voltage to the DC bus. Additionally, the controller 15 ceases to operate the active rectifier 4 as an inverter and begins operating it normally as a rectifier. That is, the controller 15 biases the transistors of the active rectifier 4 to convert the AC input signal at its input to a DC voltage at its output.

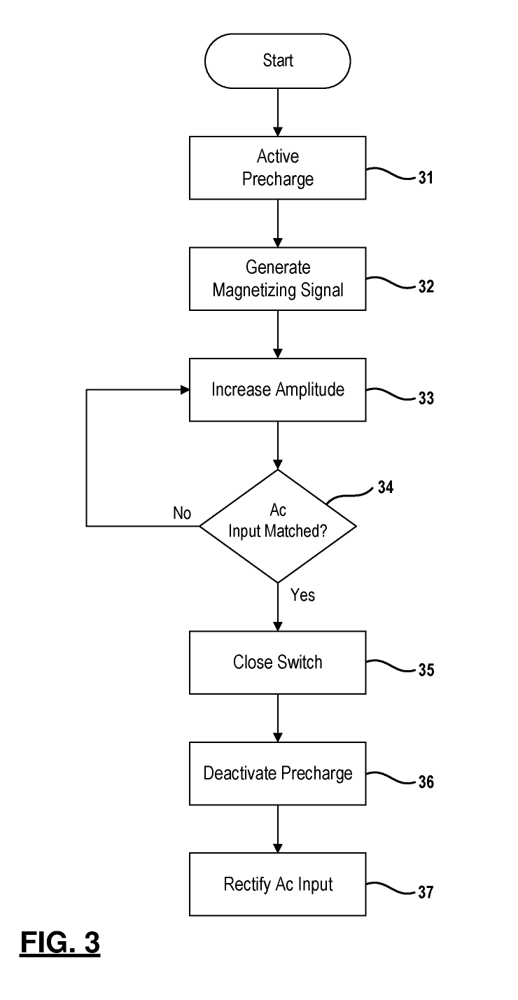

FIG. 3 further illustrates the steps taken by the controller to lower the inrush current into the uninterruptible power supply 10. Prior to energizing the system, switch 21 is open and power is not supplied to the transformer 22. During a startup phase, the precharge circuit 23 is activated at 31 by the controller 15. For example, the controller 15 closes a second switch in the precharge circuit 23 and power is supplied from the power supply 16 to the precharge circuit 23. In response to such a control signal, the precharge circuit 23 supplies a DC voltage to the DC bus (i.e., output of the active rectifier). An extra DC source 25 may also be coupled to the DC bus. In some embodiments, the controller 15 closes switch 26 to couple the extra DC source 25 to the DC bus, for example concurrently with the control signal being sent to the precharge circuit 23. In other embodiments, the battery switch 26 is closed manually by an operator. For example, the controller 15 may present a message on a display that triggers the operator to close the switch and the message is presented once precharge has been activated.

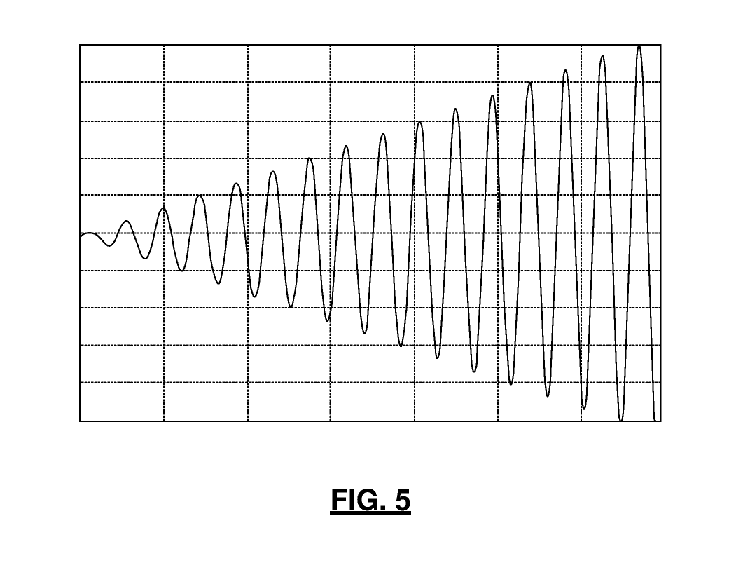

Next, the controller 15, in conjunction with the precharge circuit 23, generates a signal at 32 that magnetizes the core of the transformer 22. To do so, the controller 15 operates the active rectifier 4 as an inverter. It is important to increase magnetizing flux from zero to a steady-state without having the transformer saturate. In one embodiment, the magnitude of the AC voltage applied to the secondary winding of the transformer is initially less than the magnitude of the AC voltage from the power supply and close to zero. The magnitude of the AC voltage is increased gradually over time until the magnitude of the AC voltage on primary winding of the transformer reaches the magnitude of the AC input voltage as seen in FIG. 5. For example, the voltage may be ramped up from zero to 230 volts over a period of time ranging from 200 ms to 1 second. The voltage may be ramped up linearly, exponentially or in a stepped fashion. The goal is to have the sinusoidal voltage similar in both phase and magnitude on both side of switch 21. Upon determining the waveforms match at 34, the controller 15 closes the switch 21 as indicated at 35. In this way, because the core of the transformer 22 is pre-magnetized, only steady state current will flow and thereby minimize any inrush current.

After the startup phase (i.e., after switch 21 is closed), the controller 15 deactivates the precharge circuit 23 at 36, for example by opening the second switch in the precharge circuit path. The controller 15 also ceases operating the active rectifier 4 as an inverter and resumes normal operation of the rectifier at 37. That is, the controller 15 biases the transistors of the active rectifier 4 such that it converts an AC voltage at its input to a DC voltage at its output. After switch 21 is closed, the extra DC source may be decoupled from the DC bus or, in some cases, it may remain connected to the DC bus. It is to be understood that only the relevant steps of the methodology are discussed in relation to FIG. 3, but that other software-implemented instructions may be needed to control and manage the overall operation of the system.

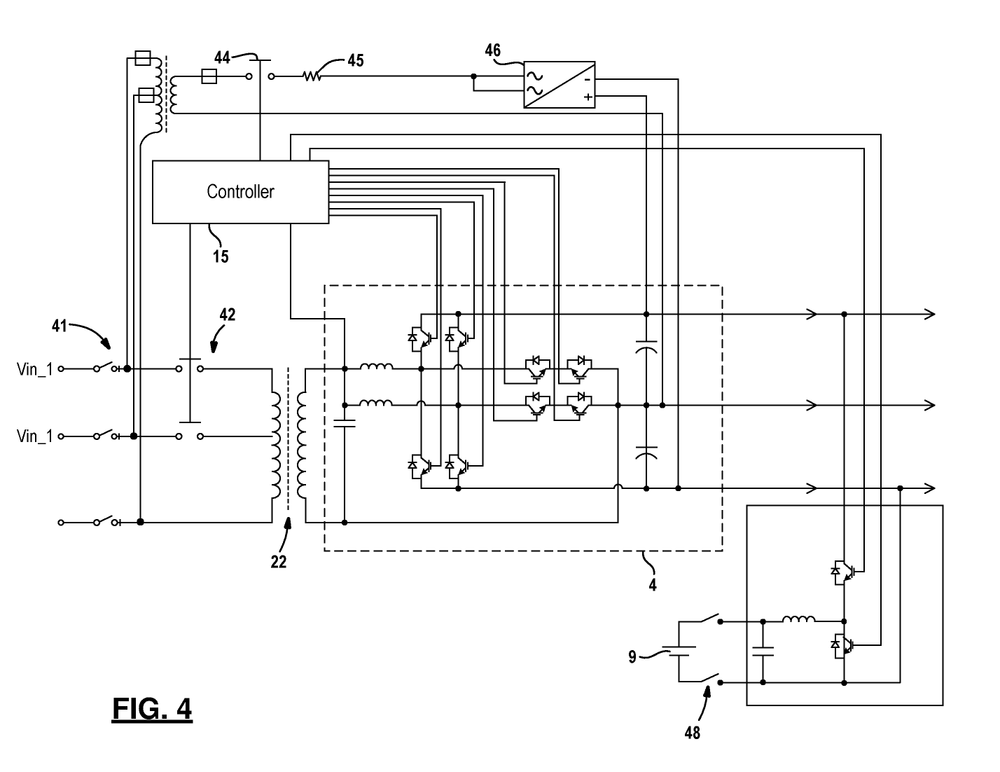

FIG. 4 depicts an example embodiment for a portion of a power supply system 40. The depicted portion includes the input transformer 22, the active rectifier 4 and the controller 15. The input transformer 22 is electrically coupled between a primary power source (not shown) and the active rectifier 4. Again, the transformer can have multiple taps at its primary side to adapt different voltages. The circuit path between the primary power source and the transformer 22 further includes two switches. One switch 41 is a user actuated switch for powering on and off the power supply system 40; whereas, the second switch 42 is interfaced with the controller 15. The second switch 42 is used to implement a startup phase and thus corresponds to switch 21 described above.

In the example embodiment, the active rectifier 4 is comprised of a plurality of transistors. Specifically, the transistors are arranged as a 3-level T-type neutral point clamp. Other types of arrangements for the rectifier fall within the scope of this disclosure.

In the example embodiment, the DC bus precharge circuit 23 is implemented by a precharge switch 44 coupled in series with a rectifier 46. In this example, the precharge switch 44 is further defined as a relay and the rectifier 46 is a diode bridge although other arrangements are contemplated as well. The precharge switch 44 is controlled by the controller 15 during the startup phase and after the startup phase in the manner described above. A resistor 45 may be electrically coupled between the precharge switch 44 and the rectifier 46. An auxiliary transformer 44 may also be used to electrically couple the precharge circuit 23 to the primary power supply.

In this embodiment, the battery 9 from the UPS serves as an extra DC source during the startup phase. The battery 9 is coupled via a user actuated switch 48 to an output side of the active rectifier 4. The operator is prompted to close the switch 48 once the precharge has been activated. In this way, the battery 9 can supply part of the energy needed to magnetize the transformer during the startup phase. It is understood that other DC source may be integrated into the system within the broader aspects of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A power supply system, comprising:
a transformer having a primary winding and a secondary winding, where the primary winding is configured to receive an AC input signal from a power supply;
a switch electrically coupled between the power supply and the primary winding of the transformer;
an active rectifier electrically coupled between the secondary winding of the transformer and a DC bus;
a precharge circuit electrically coupled between the power supply and the DC bus and, in response to a control signal, applies a DC voltage to the DC bus; and
a controller interfaced with the precharge circuit and the active rectifier, wherein the controller determines when AC voltage at the primary winding of the transformer equals the AC input signal and closes the switch in response to a determination that the AC voltage at the primary winding of the transformer substantially equals the AC input signal.

2. The power supply system of claim 1 wherein the controller provides the control signal to the precharge circuit during a startup phase and discontinues providing the control signal to the precharge circuit in response to a determination that the AC voltage at the primary winding of the transformer substantially equals the AC input signal.

3. The power supply system of claim 2 wherein the controller operates the active rectifier as an inverter during the startup phase.

4. The power supply system of claim 2 wherein the active rectifier includes at least one transistor and the controller controls biasing of the at least one transistor of the active rectifier to generate an AC voltage at an input of the active rectifier during the startup phase.

5. The power supply system of claim 4 wherein the controller biases the at least one transistor of the active rectifier to generate an AC voltage having a magnitude less than magnitude of the AC input signal and increases magnitude of the AC voltage over time until it equals magnitude of the AC input signal.

6. The power supply system of claim 4 wherein the controller controls biasing of the at least one transistor to convert the AC input signal at the input of the active rectifier to a DC voltage after the startup phase.

7. The power supply system of claim 1 wherein the active rectifier is a 3-level T-type neutral point clamp.

8. The power supply system of claim 1 wherein the precharge circuit includes a precharge switch and a rectifier coupled in series between the power supply and the DC bus.

9. The power supply system of claim 8 further comprises an extra DC source that selectively couples to the DC bus during the startup phase.

10. The power supply system of claim 1 further comprises a battery electrically coupled to the DC bus, and an inverter electrically coupled between the DC bus and a load, where the inverter is configured to receive input from the active rectifier and the battery.

11. A method for lowering inrush current to an uninterruptible power supply, comprising:
providing a transformer having a primary winding and a secondary winding, where the primary winding is configured to receive an AC input signal from a power supply;
opening, by a controller, a switch interposed between the power supply and the primary winding of the transformer during a startup phase;
applying an AC voltage via an active rectifier to the secondary winding of the transformer, where magnitude of the AC voltage is less than magnitude of the AC input signal;
increasing, by a controller, the magnitude of the AC voltage over time until the magnitude of the AC voltage on primary winding of the transformer equals magnitude of the AC input signal;
determining, by the controller, whether the magnitude of the AC voltage on primary winding of the transformer equals the magnitude of the AC input signal; and
closing, by the controller, the switch in response to a determination by the controller that the magnitude of the AC voltage equals the magnitude of the AC input signal.

12. The method of claim 11 further comprises operating, by the controller, the active rectifier as an inverter during the startup phase, where the active rectifier is interposed between the secondary winding of the transformer and a load.

13. The method of claim 12 further comprises supplying the AC input signal via a precharge circuit path to the active rectifier during the startup phase, where the AC input signal is supplied as a DC voltage to an output of the active rectifier.

14. The method of claim 13 further comprises supplying DC voltage to the output of the active rectifier from another voltage source which differs from the power supply.

15. The method of claim 12 further comprises biasing at least one transistor of the active rectifier to generate the AC voltage at the secondary winding of the transformer.

16. The method of claim 13 further comprises cease applying the AC voltage to the secondary winding of the transformer in response to a determination by the controller that the magnitude of the AC voltage equals the magnitude of the AC input signal.

17. The method of claim 16 further comprises opening, by the controller, a second switch in the precharge circuit path and thereby cease applying the AC voltage to the secondary winding of the transformer.

18. The method of claim 11 further comprises biasing, by the controller, the at least one transistor of the active rectifier to convert the AC input signal to a DC voltage after the startup phase.
